(19) United States
(12) Patent Application Publication
(10) Pub. No.: US 2014/0364236 A1
(43) Pub. Date: Dec. 11, 2014

(54) SYSTEM AND METHOD FOR TRAPPING ENEMY UNITS IN A GAME

(71) Applicant: Zynga Inc., San Francisco, CA (US)

(72) Inventor: Matthew Robert Read, Encinitas, CA (US)

(73) Assignee: Zynga Inc., San Francisco, CA (US)

(21) Appl. No.: 14/254,361

(22) Filed: Apr. 16, 2014

Related U.S. Application Data
(60) Provisional application No. 61/831,232, filed on Jun. 5, 2013.

(51) Int. Cl. A63F 13/50; A63F 13/87

(52) U.S. Cl. CPC A63F 13/50; A63F 13/87
USPC 463/40

(57) ABSTRACT

Methods and systems are directed to the trapping of enemy units in a game. A game may give each player control of a certain territory or area. Each player may build or place buildings within their territory. Each player may build units capable of attacking the territory of one or more other players. One or more players may place traps within their territory. An attacking enemy unit may be captured by the trap. A captured unit may be put to work for the capturing player (e.g., to generate resources for the capturing player). In some example embodiments, a captured unit may be freed in a later attack, and resume fighting for its former controller or its liberator.

### CLAIM OF PRIORITY UNDER 35 U.S.C. §119(e)

The present application claims priority to and incorporates by reference U.S. Provisional Application No. 61/831,232, filed Jun. 5, 2013, entitled “System and Method for Trapping Enemy Units in a Game.”

### TECHNICAL FIELD

The subject matter disclosed herein generally relates to computer-implemented games. Specifically, in one example, the present disclosure addresses systems and methods to manipulate units in a game.

### BACKGROUND

In competitive strategy games, such as strategy games with a military theme, players may build or recruit units. A player's units may be used to attack territory or units controlled by other players, to defend the territory of the owning player, or to gather resources.

In online games, a number of in-game currencies may be used for acquiring in-game assets. One or more of the currencies may be earned through in-game activity, while one or more of the currencies may be purchasable with real-world money.

### BRIEF DESCRIPTION OF THE DRAWINGS

Some embodiments are illustrated by way of example and not limitation in the figures of the accompanying drawings.

FIG. 1 is a block diagram illustrating an example of a system for implementing particular disclosed embodiments.

FIG. 2 is a block diagram illustrating an example social network.

FIG. 3A is a pair of block diagrams illustrating components of a server machine or a client machine suitable for implementing particular disclosed embodiments.

FIG. 3B is a block diagram illustrating components of a game engine suitable for implementing particular disclosed embodiments.

FIG. 4 is a block diagram illustrating an example user interface of an example game instance.

FIG. 5 is a block diagram illustrating an example user interface of an example game instance.

FIG. 6 is a block diagram illustrating an example user interface of an example game instance.

FIG. 7 is a flow chart illustrating operations of a device in performing particular disclosed embodiments.

FIG. 8 is a flow chart illustrating operations of a device in performing particular disclosed embodiments.

FIG. 9 is a flow chart illustrating operations of a device in performing particular disclosed embodiments.

FIG. 10 is a flow chart illustrating operations of a device in performing particular disclosed embodiments.

FIG. 11 is a flow chart illustrating an example data flow in a system.

FIG. 12 is a network diagram illustrating an example network environment.

FIG. 13 is a block diagram illustrating an example computer system architecture.

### DETAILED DESCRIPTION

Example methods and systems are directed to the trapping of enemy units in a game. Game mechanics of a computer-implemented game may include a trapping mechanism that provides a trap object which is placeable at a player-selected position on a virtual game board. Predetermined interaction by enemy/opposition units with the trap object can automatically result in trapping or capture of the enemy/opposition units. Examples typify possible variations. Some components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some example embodiments, a game gives each player control of a certain territory or area on a virtual gameboard or within a virtual in-game space. Each player may build or place buildings (e.g., unit production buildings, resource production buildings, defensive buildings, research buildings, or any suitable combination thereof) within their territory. Each player may build units capable of attacking the territory of one or more other players.

In some example embodiments, one or more players place traps within their territory. In some example embodiments, a player may place traps outside their territory. An attacking enemy unit may be captured by the trap by predetermined interaction with the trap (e.g., by moving onto the trap, moving within a certain range of the trap, randomly being selected, or any suitable combination thereof). Capture criteria (i.e., the particular predetermined interaction that results in unit capture) may be universal to all traps within the game, or may be different for different types of traps available in the game.

Effects of trap capture on captured units may include use of the captured unit by the capturing player for predefined purposes/functionalities. For example, the captured unit may be put to work for the capturing player (e.g., to generate resources for the capturing player). In some example embodiments, a captured unit may be freed in a later attack, and resume fighting for its former controller, its liberator, or both.

Each trap placed on the gameboard may be visible only to the player responsible for placement of the trap. In such cases, a game view showing a particular area of the game board may be generated such as to omit from the game view one or more traps placed in the particular area by another player.

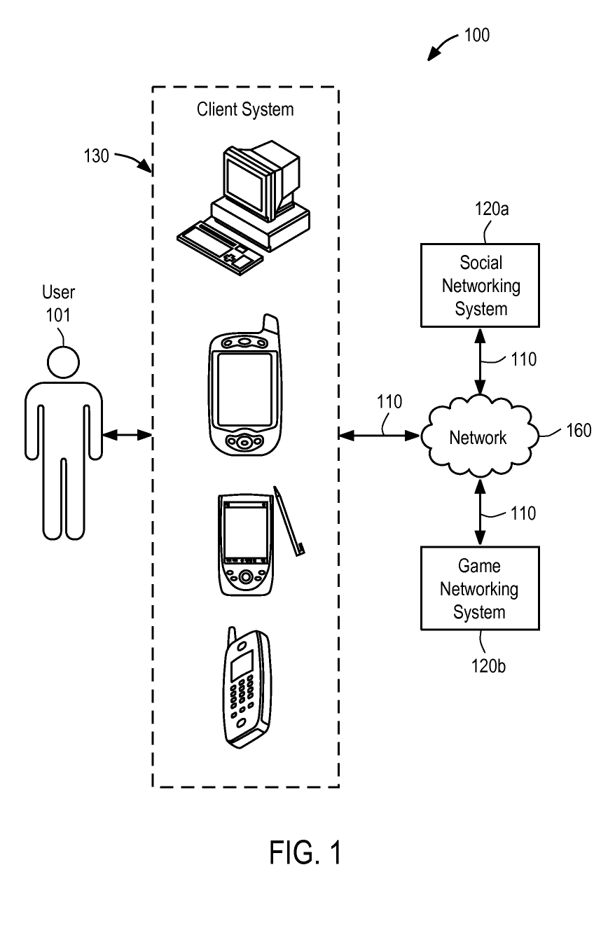

FIG. 1 illustrates an example of a system 100 for implementing various disclosed embodiments. In particular embodiments, system 100 comprises user 101, social networking system 120a, game networking system 120b, client system 130, and network 160. The components of system 100 can be connected to each other in any suitable configuration, using any suitable type of connection. The components may be connected directly or over the network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 120a is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. User 101 may use client system 130 to access, send data to, and receive data from social networking system 120a and game networking system 120b. The user 101 may be a player of one or more of the games hosted by the game networking system 120b. Client system 130 can access social networking system 120a or game networking system 120b directly, via network 160, or via a third-party system. As an example and not by way of limitation, client system 130 may access game networking system 120b via social networking system 120a. Client system 130 can be any suitable computing device, such as a personal computer, laptop, cellular phone, smart phone, computing tablet, and so forth.

Although FIG. 1 illustrates a particular number of users 101, social networking systems 120a, game networking systems 120b, client systems 130, and networks 160, this disclosure contemplates any suitable number of users 101, social networking systems 120a, game networking systems 120b, client systems 130, and networks 160. As an example and not by way of limitation, system 100 may include one or more game networking systems 120b and no social networking systems 120a. As another example and not by way of limitation, system 100 may include a system that comprises both social networking system 120a and game networking system 120b. Moreover, although FIG. 1 illustrates a particular arrangement of user 101, social networking system 120a, game networking system 120b, client system 130, and network 160, this disclosure contemplates any suitable arrangement of user 101, social networking system 120a, game networking system 120b, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. Connections 110 need not necessarily be the same throughout system 100. One or more first connections 110 may differ in one or more respects from one or more second connections 110. Although FIG. 1 illustrates particular connections between user 101, social networking system 120a, game networking system 120b, client system 130, and network 160, this disclosure contemplates any suitable connections between user 101, social networking system 120a, game networking system 120b, client system 130, and network 160. As an example and not by way of limitation, in particular embodiments, client system 130 may have a direct connection to social networking system 120a or game networking system 120b, bypassing network 160.

### Online Games and Game Systems—Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each user 101 controls one or more player characters (PCs). The game engine controls all other aspects of the game, including non-player characters NPCs, and in-game objects. The game engine also manages game state, including player character state for currently active (online) and inactive (offline) players.

An online game can be hosted by game networking system 120b, which can be accessed using any suitable connection with a suitable client system 130. A user 101 may have a game account on game networking system 120b, wherein the game account can contain a variety of information associated with the user 101 (e.g., the player's personal information, financial information, purchase history, player character state, game state). In some embodiments, a user 101 may play multiple games on game networking system 120b, which may maintain a single game account for the user 101 with respect to all the games, or multiple individual game accounts for each game with respect to the user 101. In some embodiments, game networking system 120b can assign a unique identifier to each user 101 of an online game hosted on game networking system 120b. Game networking system 120b can determine that a user 101 is accessing the online game by reading the user's cookies, which may be appended to hypertext transport protocol (HTTP) requests transmitted by client system 130, and/or by the user 101 logging onto the online game.

In particular embodiments, user 101 may access an online game and control the game's progress via client system 130 (e.g., by inputting commands to the game at the client device). Client system 130 can display the game interface, receive inputs from user 101, transmit user inputs or other events to the game engine, and receive instructions from the game engine. The game engine can be executed on any suitable system (such as, for example, client system 130, social networking system 120a, or game networking system 120b). As an example and not by way of limitation, client system 130 can download client components of an online game, which are executed locally, while a remote game server, such as game networking system 120b, provides backend support for the client components and may be responsible for maintaining application data of the game, processing the inputs from the user 101, updating and/or synchronizing the game state based on the game logic and each input from the user 101, and transmitting instructions to client system 130. As another example and not by way of limitation, each time user 101 provides an input to the game through the client system 130 (such as, for example, by typing on the keyboard or clicking the mouse of client system 130), the client components of the game may transmit the player's input to game networking system 120b. The social networking system 120a, game networking system 120b, and client system 130 may be implemented using hardware such as that described with respect to FIG. 13, below.

### Online Games and Game Systems—Game Play

In particular embodiments, user 101 can engage in or cause a player character controlled by him to engage in one or more in-game actions. For a particular game, various types of in-game actions may be available to user 101. As an example and not by way of limitation, a player character in an online role-playing game may be able to interact with other player characters, build a virtual house, attack enemies, go on a quest, and go to a virtual store to buy/sell virtual items. In another example, a player character in an online strategy war game may be able to attack the territory of another player, defend the territory of the player, assist in the defense of another player's territory, or any suitable combination thereof.

In particular embodiments, user 101 may engage in an in-game action by providing one or more user inputs to client system 130. Various actions may call for various types and numbers of user inputs. Some types of in-game actions may call for a single user input. As an example and not by way of limitation, user 101 may be able to harvest a virtual crop by clicking on it once with a mouse. Some types of in-game actions may call for multiple user inputs. As another example and not by way of limitation, user 101 may be able throw a virtual fireball at an in-game object by entering the following sequence on a keyboard: DOWN, DOWN and RIGHT, RIGHT, B. This disclosure contemplates engaging in in-game actions using any suitable number and type of user inputs.

In particular embodiments, user 101 can perform an in-game action on an in-game object. An in-game object is any interactive element of an online game. In-game objects may include, for example, PCs, NPCs, in-game assets and other virtual items, in-game obstacles, game elements, game features, and other in-game objects. This disclosure contemplates performing in-game actions on any suitable in-game objects. For a particular in-game object, various types of in-game actions may be available to the player based on the type of in-game object. As an example and not by way of limitation, if the player encounters a virtual bear, the game engine may give him the options of shooting the bear or petting the bear. Some in-game actions may be available for particular types of in-game objects but not other types. As an example and not by way of limitation, if the player encounters a virtual rock, the game engine may give him the option of moving the rock; however, unlike with the virtual bear, the game engine may not allow the player to shoot or pet the virtual rock. Furthermore, for a particular in-game object, various types of in-game actions may be available to the player based on the game state of the in-game object. As an example and not by way of limitation, if the player encounters a virtual crop that was recently planted, the game engine may give him only the option of fertilizing the crop, but if the player returns to the virtual crop later when it is fully grown, the game engine may give him only the option of harvesting the crop.

In particular embodiments, the game engine may cause one or more game events to occur in the game. Game events may include, for example, a change in game state, an outcome of an engagement, a completion of an in-game obstacle, a transfer of an in-game asset or other virtual item, or a provision of access, rights, and/or benefits. In particular embodiments, a game event is any change in game state. Similarly, any change in game state may be a game event. This disclosure contemplates any suitable type of game event. As an example and not by way of limitation, the game engine may cause a game event where the virtual world cycles between daytime and nighttime every 24 hours. As another example and not by way of limitation, the game engine may cause a game event where a new instance, level, or area of the game becomes available to the player. As yet another example and not by way of limitation, the game engine may cause a game event where the user 101's player character heals one hit point every 5 minutes.

In particular embodiments, a game event or change in game state may be an outcome of one or more in-game actions. The game engine can determine the outcome of a game event or a change in game state according to a variety of factors, such as, for example, game logic or rules, player character in-game actions, player character state, game state of one or more in-game objects, interactions of other player characters, or random calculations. As an example and not by way of limitation, the player may overcome an in-game obstacle and earn sufficient experience points to advance to the next level, thereby changing the game state of the user 101's player character (e.g., it advances to the next character level). As another example and not by way of limitation, the player may defeat a particular boss NPC in a game instance, thereby causing a game event where the game instance is completed and the player advances to a new game instance. As yet another example and not by way of limitation, the player may pick the lock on a virtual door to open it, thereby changing the game state of the door (it goes from closed to open) and causing a game event (the player can access a new area of the game).

In particular embodiments, the user 101 may access particular game instances of an online game. A game instance is a copy of a specific game play area that is created during runtime. In particular embodiments, a game instance is a discrete game play area where one or more players can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more users 101 and one or more in-game objects controlled by the game engine. When accessing an online game, the game engine may allow the user 101 to select a particular game instance to play from a plurality of game instances. Alternatively, the game engine may automatically select the game instance that the user 101 will access. In particular embodiments, an online game comprises only one game instance that all users 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

### Social Graphs and Social Networking Systems

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure contemplates any suitable social graph users.

The minimum number of edges connecting a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 120a or game networking system 120b). In one embodiment, Nₘₐₓ equals 1, such that the player's social network includes only first-degree friends. In another embodiment, Nₘₐₓ is unlimited.

In particular embodiments, the social graph is managed by game networking system 120b, which is managed by the game operator. In other embodiments, the social graph is part of a social networking system 120a managed by a third-party (e.g., Facebook, Friendster, Myspace). In yet other embodiments, the user 101 has a social network on both game networking system 120b and social networking system 120a, wherein the user 101 can have a social network on the game networking system 120b that is a subset, superset, or independent of the player's social network on social networking system 120a. In such combined systems, game networking system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

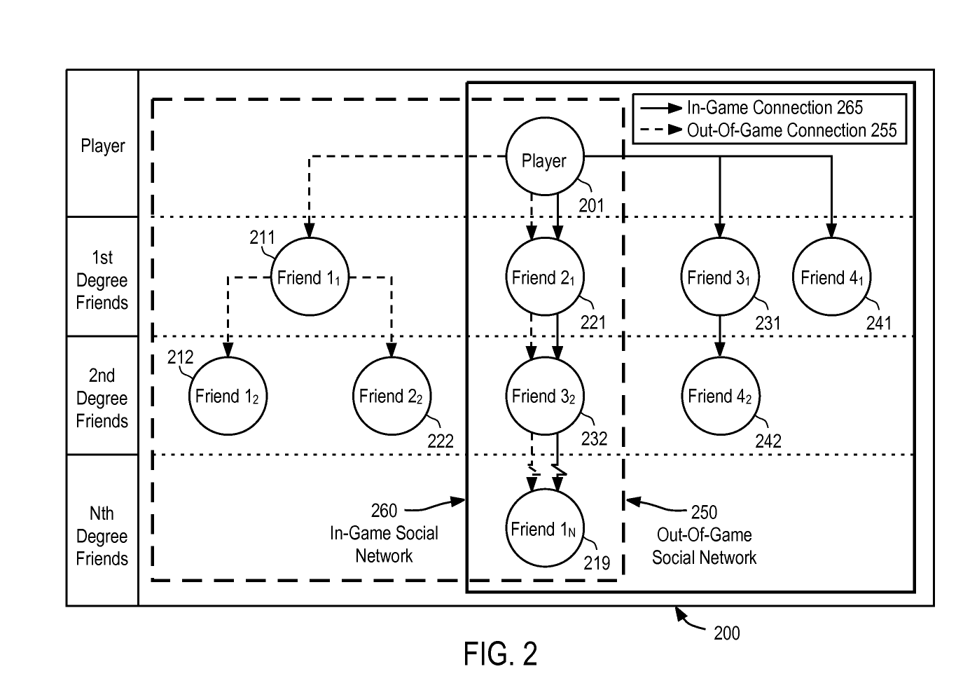

FIG. 2 shows an example of a social network 200 within a social graph. As shown, Player 201 can be associated, connected or linked to various other users, or “friends,” within the social network 200. These associations, connections or links can track relationships between users within the social network 200 and are commonly referred to as online “friends” or “friendships” between users. Each friend or friendship in a particular user's social network within a social graph is commonly referred to as a “node.” For purposes of illustration and not by way of limitation, the details of social network 200 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge connecting to connect a player to another user is considered the degree of separation. For example, FIG. 2 shows that Player 201 has four second-degree friends to which he is connected via his connection to his first-degree friends. Second-degree friends “Friend 1₂” 212 and “Friend 2₂” 222 are connected to Player 201 via his first-degree friend “Friend 1₁” 211, while Friend 3₂ and Friend 4₂ are connected to Player 201 via other first-degree friends. The limit on the depth of friend connections, or the number of degrees of separation for associations, that Player 201 is allowed is typically dictated by the restrictions and policies implemented by social networking system 120a.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may benefit from and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks 260, 250. In some embodiments, it is possible for Player 201 to have a friend connected to him both in his in-game and out-of-game social networks 260, 250, wherein the friend is at different degrees of separation in each network. For example, if Friend 2₂ 222 had a direct in-game connection with Player 201, Friend 2₂ 222 would be a second-degree friend in Player 201's out-of-game social network 250, but a first-degree friend in Player 201's in-game social network 260. In particular embodiments, a game engine can access in-game social network 260, out-of-game social network 250, or both.

In particular embodiments, the connections in a player's in-game social network 260 can be formed both explicitly (e.g., users have to “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are friends in real life (i.e., in disintermediated interactions or the like), but that could be the case.

### Asynchronous Game Play

In multiplayer online games, two or more players can play in the same game instance. Game play is asynchronous when the players do not play simultaneously in the game instance. In particular embodiments, synchronous game play between two players in the same game instance can be simulated from asynchronous game play by recording the game play of a first player in the game instance at a first time and replaying that game play during the game play of a second player in the game instance at a later time.

### Example System

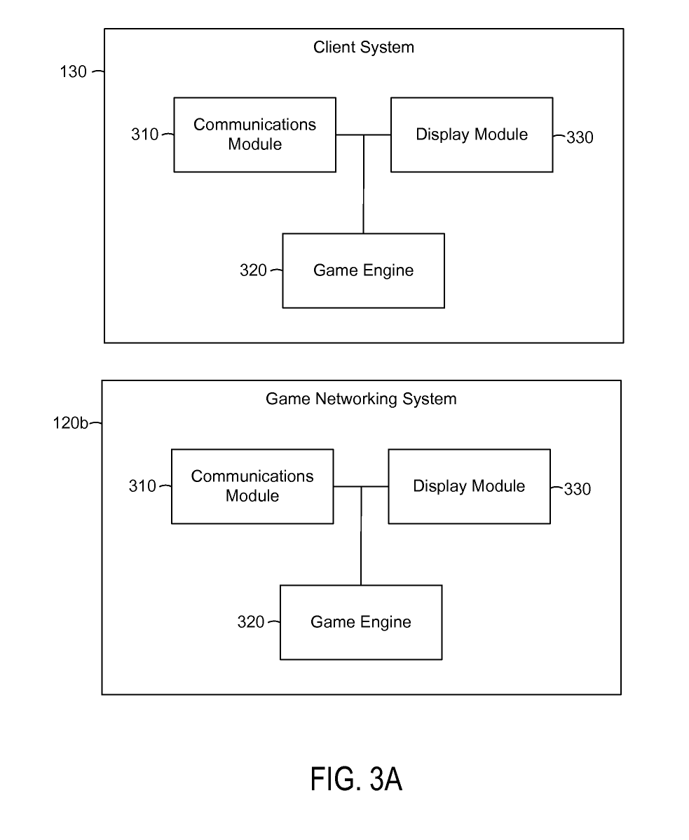

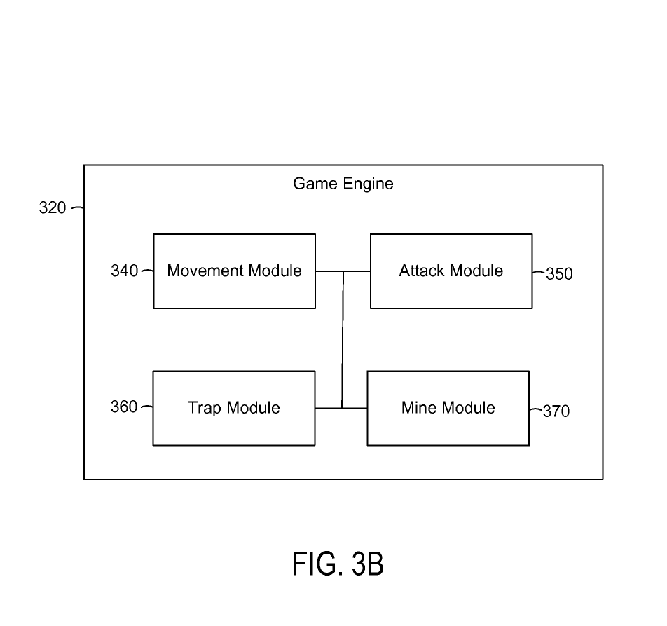

FIG. 3A is a pair of block diagrams illustrating components of the client system 130 and the game networking system 120b, according to some example embodiments. The client system 130 is shown as including a communications module 310, a game engine 320, and a display module 330, all configured to communicate with each other (e.g., via a bus, shared memory, or a switch). The game networking system 120b is also shown as including a communications module 310, a game engine 320, and a display module 330, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communications module 310 may be configured to send and receive data between the client system 130 and the game networking system 120b. For example, the client system 130 may send data including the game choices made by the user to the game networking system 120b via the communications module 310. As another example, the game networking system 120b may receive the game choices via the communications module 310, process them using the game engine 320, and send a response via the communications module 310. In some example embodiments, the display module 330 of the game networking system 120b causes the display of results from the game action on the client system 130. In some example embodiments, the display module 330 of the client system 130 interprets results received by the communications module 310 and causes the display of results from the game action on the client system 130. Calculation of the results of the game action may be performed in the game engine 320 of the client system 130, the game engine 320 of the game networking system 120b, or both.

FIG. 3B is a block diagram illustrating the components of the game engine 320, according to some example embodiments. The game engine 320 is shown as comprising a movement module 340, an attack module 350, a trap module 360, and a mine module 370, all configured to communicate with each other (e.g., via a bus, shared memory, or a switch).

The movement module 340 may control the movement of units within the game. For example, a player may send a command to one or more units to attack a building in an enemy territory. The units may move across a play area to reach the building. The units may move in straight lines or along a grid. For example, the position of the units may be defined in (x,y) coordinates, with the size of the coordinate grid such that each unit is much larger than a single coordinate element. In this way, the units may appear to be arbitrarily placed relative to the coordinate grid. In another example, the position of the units may be defined as a position on a grid, with the size of the coordinate grid such that each unit is similar in size to a single coordinate element (e.g., the same size, half of the size, twice the size, or the like). In this way, the units may appear to be placed in a limited set of positions relative to the playing area. The movement module 340 may take into account a number of factors in determining the movement of a unit. For example, a speed of the unit, a movement modifier (e.g., a terrain modifier) of the play area the unit is on, an attribute of the player controlling the unit (e.g., a researched speed bonus), an attribute of the player controlling the play area (e.g., a defensive spell causing a speed penalty to enemy units), a health of the unit (e.g., a speed reduction due to damage taken), and so on.

By way of example, the A* algorithm may be used to determine the path taken by a unit in getting from a starting location to a destination location. During the movement of the unit, the speed of the unit may be determined by the following formula: (Unit Base Speed)×(Terrain Modifier)×(Player Bonus)×(Opponent Penalty). For example, a unit may have a base speed of 50 pixels/second, 2 tiles/day, or 100 miles/hour. On flat terrain, the terrain modifier may be 1.0; on swampy terrain, the terrain modifier may be 0.5; on mountain terrain, the terrain modifier may be 0.75. A player may ordinarily not have a player bonus, and 1.0 may be used for the player bonus element. The player may have a temporary power up providing 25% increased movement speed, and 1.25 may be used for the player bonus element. Likewise, the opponent may not ordinarily have an opponent penalty, and 1.0 may be used for the opponent penalty element. The player may cast a defensive spell providing 25% reduced movement speed, and 0.75 may be used for the player bonus element. Thus, in an example embodiment, a unit with a speed of 50 pixels/second belonging to a player with a speed bonus (1.25) on swampy terrain (0.5) attacking a player having a movement penalty (0.75) would have a resulting speed of 23.4375 pixels/second. In some example embodiments, the speed is rounded to a game- or processor-determined degree of precision. For example, the speed of 23.4375 pixels/second may be rounded to 23 pixels/second. In some example embodiments, more or fewer elements are used to calculate the unit speed. For example, a terrain modifier may not be used.

The attack module 350 may control the ability of units within the game to deal damage to each other. For example, a unit may have an attack capable of dealing damage at a range. After the movement module 340 has moved the unit to within its range of a target unit (e.g., a target building), the attack module 350 may determine the damage dealt by the attacking unit. The damage may be based on an attack value of the attacking unit, a defense value of the defending unit, a random element, cover provided to the defending unit by terrain, a high-ground bonus provided to the attacking unit by terrain, a range factor (e.g., a decrease in damage at long range or an increase in damage at close range), and so on.

By way of example, the damage dealt may be determined by the following formula: (Attack Value)×(Range Modifier)×(Terrain Modifiers)×(Random Factor)/(Defense Value). For example, a unit may have an attack value of 100. The range modifier may depend on the unit. For example, dispersed gas may do much less damage at its maximum range than close-up, while a rifle bullet deals very similar damage at close range and maximum range. For this example, consider a range modifier that varies linearly with distance, from 1.0 at point-blank range to 0.0 at a maximum range of 200 pixels. Example terrain modifiers are a 1.5 multiplier for the attacker being on higher ground than the defender, and an 0.75 multiplier for the defender being in forest territory that provides some cover. In this example, consider a defending unit with a defense value of 80. Thus, based on the fixed elements, the damage dealt will be 100×0.5×1.5×0.75×(Random Factor)/8, where the range is 100 pixels, resulting in an 0.5 range modifier. As a result, the damage dealt will be 7.03125 multiplied by the Random Factor. The Random Factor may be a random value in any predefined range (for example, between 0 and 1 or between 50 and 100). The Random Factor may be linearly distributed, follow a Gaussian distribution, or use some other distribution.

The trap module 360 may control the ability of traps within the game to capture units based on predetermined conditions. For example, a trap may have a trapping factor and a unit may have a resistance factor. Based on a comparison between the trapping factor and the resistance factor, a probability of trapping the unit may be calculated.

By way of example, consider a trap with a trapping factor of 100 within a first radius of the center of the trap and a trapping factor of 50 within a second radius. Also consider a unit with a resistance factor of 125. The probability of trapping the unit may be given by the formula: (Trapping Factor)/(Resistance Factor). Thus, in this example, the unit will have an 80% chance of being trapped within the first radius (e.g., 30 pixels) and a 40% chance of being trapped between the first radius and the second radius (e.g., 80 pixels).

In some example embodiments, resistance factors are not used. In these embodiments, the probability of trapping the unit may be determined based on the characteristics of the trap. In some example embodiments, the probability of trapping a unit is determined as 0% or 100%, without the application of a random factor.

The mine module 370 may determine the productivity of a mine within the game. For example, a mine may have a fixed production factor and a per-unit production factor. Units working within the mine may have production modifiers. The units working within the mine may be units belonging to the player or units that have been trapped using the trap module 360. By way of example, a production formula may be: (Fixed Production)+(Per-Unit Production)×(Unit 1 Modifier)+(Per-Unit Production)×(Unit 2 Modifier) . . . . For example, a mine may have a fixed production rate of 2 Jade/hour and a per-unit production rate of 1 Jade/hour. Three units may have been trapped and put to work in the mine. The first two units may have production modifiers of 0.75, while the third unit may have a production modifier of 1.5. Thus, the production of the mine would be 2 Jade/hour+1 Jade/hour×0.75+1 Jade/hour×0.75+1 Jade/hour×1.5=5 Jade/hour.

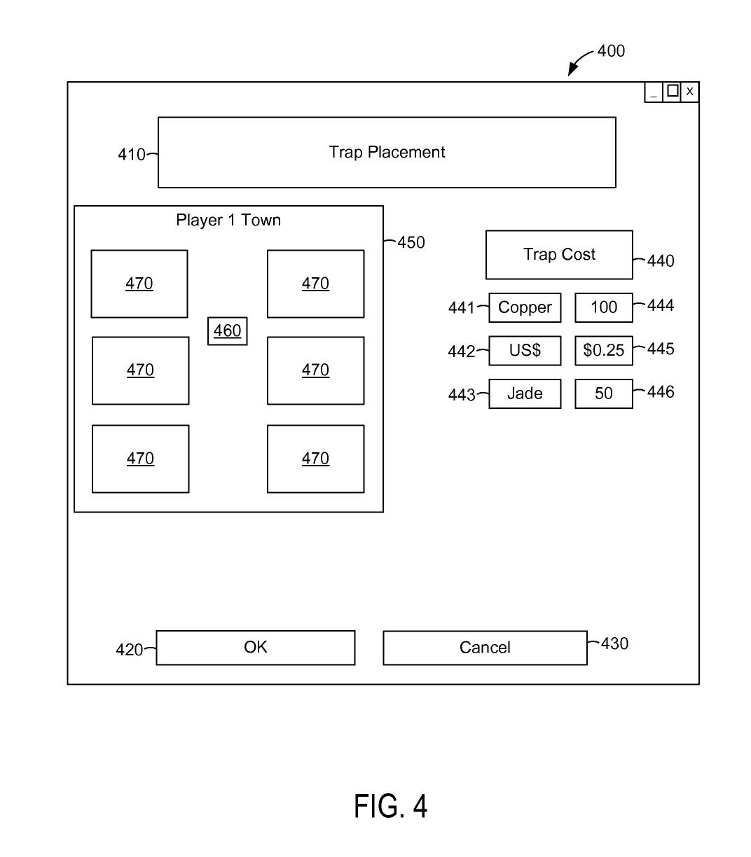

Further details regarding the functions of the modules 310-370 are discussed below, with respect to FIGS. 4-10.

FIG. 4 is a block diagram illustrating an example user interface (“UI”) of an example game instance. Shown in FIG. 4 is a UI 400, with a title 410, buttons 420 and 430, a trap cost title 440, currency labels 441-443, and currency amounts 444-446. Also shown is the player's town 450, with a trap 460 and buildings 470. The player's town 450 is an area with an in-game virtual space which is uniquely associated with the player and with respect to which the player has unique rights, thus forming the player's game instance, as mentioned above. The user of the UI 400 may be the player of the game for whom information is shown in the UI 400. Some form of authentication may be performed prior to showing the UI 400. For example, a user name and password of the user may be checked. However, it is to be understood that any user may interact with the user interface. Accordingly, in this discussion, “player” refers to a game element represented by a collection of data concerning the player, while “user” refers to the entity interacting with the UI 400.

The title 410 may indicate to the user the type of screen being displayed. For example, the title “Trap Placement” may indicate that the screen may be used to place traps in the player's town 450. The button 420, labeled “OK,” may be operable by the user to confirm the placement of traps via the UI 400. In some example embodiments, the placement of traps is automatically confirmed without an additional step by the user. The button 430, labeled “Cancel,” may be operable by the user to cancel the placement of traps via the UI 400. This may remove the just-placed traps and return the spent currency. In some example embodiments, the placement of traps cannot be canceled. The trap cost title 440 may indicate an area of the UI 400 containing data showing the cost of placing one or more traps in the player's town 450.

The currency labels 441-443 may show the different currencies with which traps may be purchased. For example, an in-game currency (e.g., Copper) may be used, a real-world currency (e.g., U.S. dollars) may be used, and a premium currency (e.g., Jade) may be used. In various embodiments, more or fewer currencies may be available to the player. In some example embodiments, the premium currency is purchasable with real-world currency. The premium currency may be unavailable for generation in-game or may be generated in-game. In some of these example embodiments, the ability to generate the premium currency in-game is substantially lower than the ability to generate a standard (e.g., non-premium) currency in-game. The currency amounts 444-446 may show the quantity of each currency needed to place a trap. In the example shown, a trap may be placed for 100 Copper, $0.25, or 50 Jade. In some example embodiments, only one of the available currencies may be used to place a trap. For example, the trap may be placed through the use of in-game currency. An additional interface may be presented to allow the user to convert premium currency or real-world currency to the in-game currency.

The player's town 450 may display all or a portion of a player's territory, thus providing a game view showing part of the gameboard or virtual space within which gameplay occurs. In some example embodiments, the player's territory may be a town. The player's territory may include one or more traps 460 and one or more buildings 470. The buildings 470 may be destroyed by attacking units during an attack. The trap 460 may capture an enemy unit during an attack, as described in more detail below.

The player may be limited to a predetermined maximum number of traps 460 within the player's town 450. For example, after placing three traps 460, the player may be prevented from placing additional traps 460. In some example embodiments, already-placed traps can be moved or removed. Removing a trap may return some or all of the resources used to place the trap. The maximum number of traps 460 that a player can place may depend on a characteristic of the player, the player's mine, or the player's guild. For example, a high-level player may be given the option to place more traps than a low-level player. As another example, a player with an upgraded mine may be given the option to place more traps than a player with a basic mine.

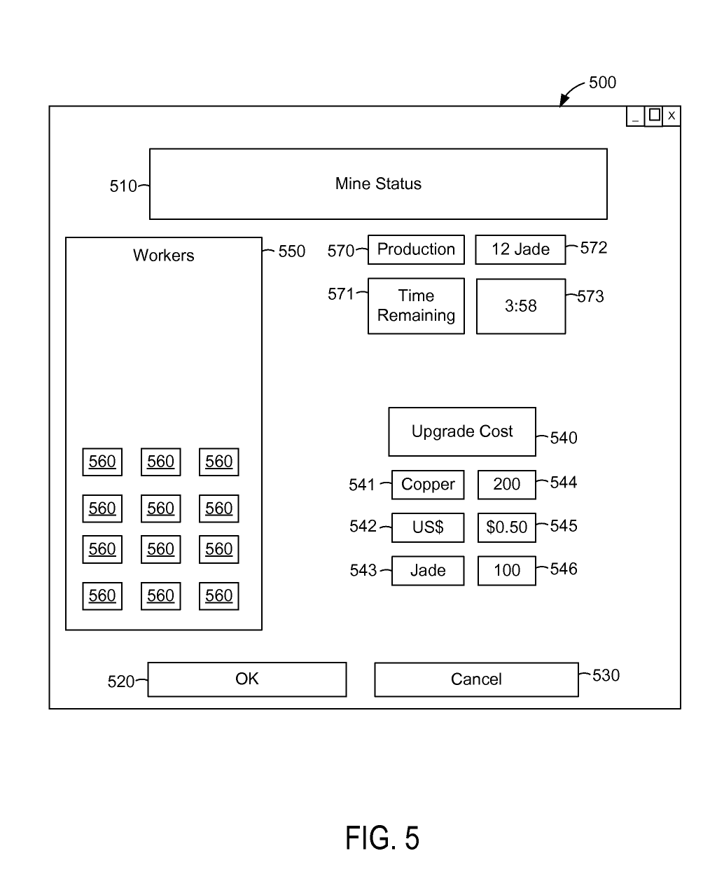

FIG. 5 is a block diagram illustrating an example user interface of an example game instance. Shown in FIG. 5 is a UI 500, with a title 510, buttons 520 and 530, an upgrade cost title 540, currency labels 541-543, currency amounts 544-546, a player's mine 550 with workers 560, production labels 570-571, and data fields 572-573 containing production details.

The title 510 may indicate to the user the type of screen being displayed. For example, the title “Mine Status” may indicate that the screen may be used to view the status of and modify one or more of the user's mines. The button 520, labeled “OK,” may be operable by the user to confirm the modification of the mine via the UI 500. In some example embodiments, the modification is automatically confirmed without an additional step by the user. The button 530, labeled “Cancel,” may be operable by the user to cancel the modification of the mine via the UI 500. This may undo the modifications and return the spent currency. In some example embodiments, the modifications cannot be canceled. The upgrade cost title 540 may indicate an area of the UI 500 containing data showing the cost of upgrading the player's mine 550.

The currency labels 541-543 may show the different currencies with which an upgrade may be purchased. For example, an in-game currency (e.g., Copper) may be used, a real-world currency (e.g., U.S. dollars) may be used, and a premium currency (e.g., Jade) may be used. In various embodiments, more or fewer currencies may be available to the player. The currency amounts 544-546 may show the quantity of each currency needed to purchase an upgrade. In the example shown, an upgrade may be placed for 200 Copper, $0.50, or 100 Jade. In some example embodiments, the upgrade provides an improved currency generation rate (e.g., additional currency each time currency is produced, more frequent production of currency, or both) or access to one or more additional types of currency (e.g., a basic mine may produce a standard currency, while an upgraded mine may produce premium currency in addition to or instead of the standard currency). As another example, a basic mine can produce a premium currency while an upgraded mine can produce the same premium currency at a faster rate.

A mine is a building that harvests one or more game resources or generates one or more currencies. The player's mine 550 may be used to produce in-game currency, premium currency, real-world currency, or any suitable combination thereof. The amount of currency produced may depend on the number or type of workers 560. In some example embodiments, the frequency of currency production depends on the number or type of workers 560. The workers 560 may have been produced by the player (e.g., purchased with one or more currencies, generated for free over time by a unit-production building in the game, or both), captured from another player (e.g., with a trap 460), or both.

The label 570 indicates that the field 572 displays the amount and type of currency being produced by the mine 550. In this example, the mine 550 produces 12 Jade each time it produces currency, as shown in field 572. The label 571 indicates that the field 573 displays the amount of time remaining before the mine 550 produces currency again. In this example, the mine 550 will produce 12 Jade after an additional 3 minutes and 58 seconds elapse, as indicated by field 573. In some example embodiments, the currency produced by the player's mine is fixed. In other example embodiments, the user is able to choose the currency produced by the player's mine 550. For example, the label 571 may be replaced by a drop-down list containing a list of currencies available for production. Based on the user selecting a different currency from the drop-down list, the production of the mine 550 may be changed to the selected currency. The time between currency productions or amount of production may depend on the selected currency. For example, a premium currency may be produced less frequently or in smaller amounts than a standard currency. As another example, the rate of production may be reduced each time the selected currency is changed and then increase while the selected currency is left unchanged.

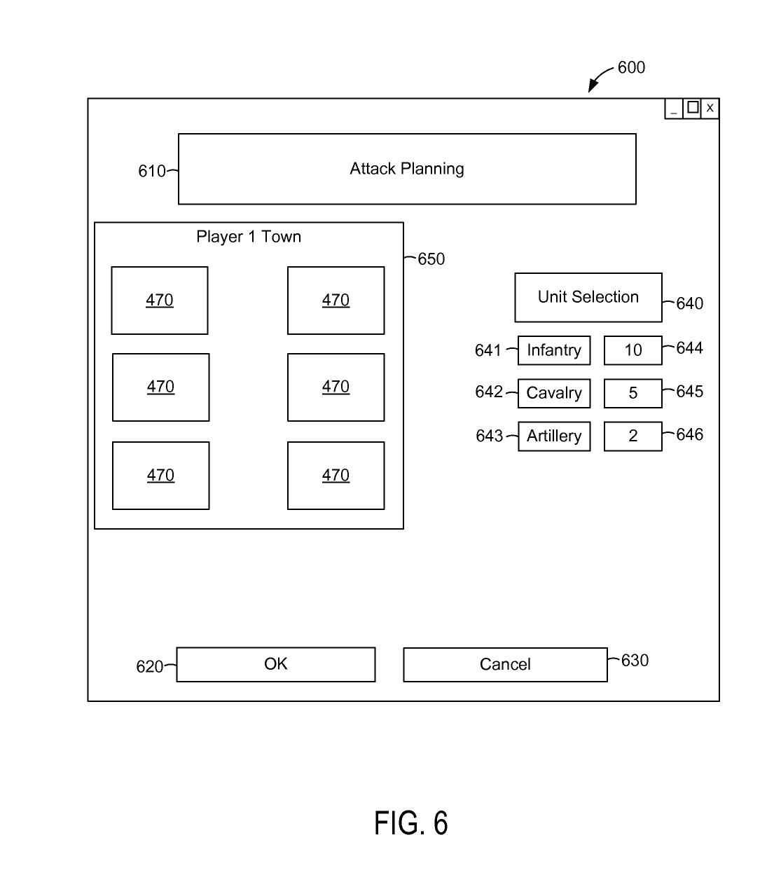

FIG. 6 is a block diagram illustrating an example user interface of an example game instance. Shown in FIG. 6 is a UI 600, with a title 610, buttons 620 and 630, a unit selection title 640, unit type labels 641-643, and unit amounts 644-646. Also shown is a target player's town 650, with buildings 470. The target player is a player other than the player associated with the user on whose device the UI 600 is displayed. The target player's town 650 is thus a display of a game instance of another player.

The title 610 may indicate to the user the type of screen being displayed. For example, the title “Attack Planning” may indicate that the screen may be used to prepare and launch an attack against another player. The button 620, labeled “OK,” may be operable by the user to confirm the attack planned via the UI 600. In some example embodiments, the attack is automatically begun as units are selected, without an additional step by the user.

The button 630, labeled “Cancel,” may be operable by the user to cancel the attack planned via the UI 600. This may undo the selections and return the selected units. In some example embodiments, the attack cannot be canceled. The unit selection title 640 may indicate an area of the UI 600 containing data regarding units selected to make the attack. The unit type labels 641-643 may show the different units with which an attack may be launched. For example, infantry, cavalry, and artillery units may be available. In various embodiments, more or fewer unit types may be available to the player. The unit amounts 644-646 may show the quantity of each unit type available or selected for the attack. In the example shown, 10 infantry, 5 cavalry, and 2 artillery units have been selected.

The target player's town 650 may display all or a portion of a player's territory. In some example embodiments, town 650 corresponds to the town 450. The display of the target player's town may include a label indicating the name of the target player. For example, the town 650 is labeled “Player 1 Town,” indicating that it is a town controlled by “Player 1.” The player's territory may include one or more traps 460 (shown in FIG. 4 and hidden in the view shown in FIG. 6) and one or more buildings 470. The buildings 470 may be destroyed by attacking units during an attack. In this view, the target player's town 650 is shown with the traps 460 hidden from view of the attacking player. In other example embodiments, the traps 460 may be shown to the attacking player.

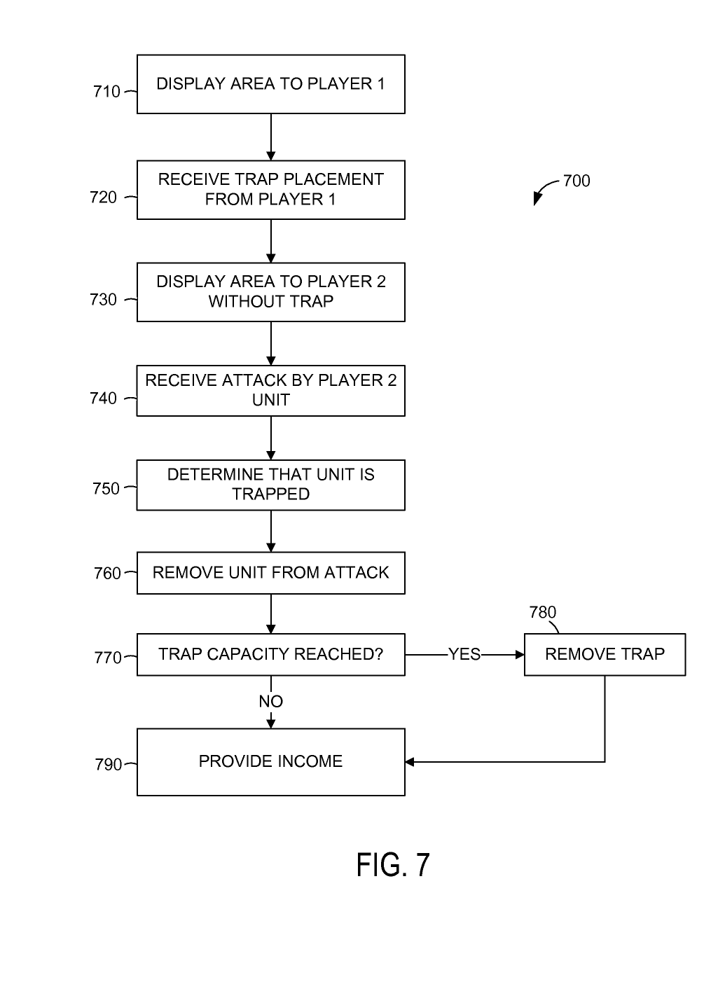

FIG. 7 is a flowchart illustrating operations of a method 700, according to some example embodiments, of trapping units in a game. The method 700 may be performed, for example, by the client system 130 or the game networking system 120b, using modules described above with respect to FIG. 3. By way of example and not limitation, this implementation is discussed below. As shown in FIG. 7, the method 700 includes operations 710, 720, 730, 740, 750, 760, 770, 780, and 790.

In operation 710, the display module 330 may cause a UI to be displayed to a first player. The UI 400 shown in FIG. 4 is an example of such a UI. The UI may display the first player's territory to the first player.

In operation 720, the communications module 310 may receive a trap placement from the first player. For example, the communications module 310 of the game networking system 120b may receive the trap placement. The trap placement may indicate a location within the first player's territory at which the trap is placed.

In operation 730, the display module 330 may cause a UI to be displayed to a second player. The UI 600 shown in FIG. 6 is an example of such a UI. The UI may display the first player's territory to the second player, while hiding the location of the trap placed in operation 720.

In operation 740, the communications module 310 may receive an attack command from the second player. The attack command may indicate one or more units of the second player participating in the attack, one or more locations within the first player's territory to place the units, or both.

In operation 750, the trap module 360 determines that the attacking unit of player 2 is trapped. The determination may be based on the attacking unit being at the location of the trap, being within a predetermined range of the trap, a trapping strength of the trap, a resistance value of the unit, or any suitable combination thereof. For example, in a particular on-line game, traps may have strengths in the range of 1-100 and units may have resistances in the same range. The percentage chance of a unit on the trap being captured may be based on the ratio between the trap strength and the unit resistance. For example, a trap with strength greater than or equal to the resistance of the unit may have a 100% chance of trapping the unit, while a trap with strength half the unit's resistance may have a 50% chance of trapping the unit. In some example embodiments, instead of having a numeric resistance, units have the property of being either trappable or not. In those embodiments, a trap can trap a trappable unit but not trap an untrappable unit.

In operation 760, the trap module 360 removes the attacking unit of player 2 from the attack. In some example embodiments, other or additional criteria are used to determine if the trap is successful. For example, there may be multiple trap types, some of which are more likely to be effective. Likewise, different attacking units may have different resistances to being trapped. For example, a cheap trap may have a 50% chance of trapping an average unit, but only a 25% chance of trapping a more powerful unit. Continuing with this example, a more powerful trap may have a 100% chance of trapping an average unit directly on the trap, a 50% chance of trapping a more powerful unit directly on the trap, and a 50% chance of trapping an average unit within a certain range. In some example embodiments, the attacking player may expend resources before the attack to prevent certain units, or all units, from being affected by traps during the attack.

In operation 770, the trap module 360 determines if the trap is to be destroyed. In some example embodiments, the trap is destroyed after a single attacking unit is trapped. In other example embodiments, the trap can trap multiple units based on an attribute of the trap (e.g., trap size, trap level, trap value, or any suitable combination thereof) or an attribute of the attacking unit (e.g., unit size, unit level, unit value, or any suitable combination thereof). If the trap is to be destroyed, the method 700 continues with operation 780. Otherwise, the method 700 moves on to operation 790.

In operation 780, the trap module 360 destroys the trap. In some example embodiments, this removes the trap from the game completely. In other example embodiments, the location of the trap is remembered, and it may be possible to replace or repair the trap.

In operation 790, the mine module 370 provides income to the player based on the trapped unit. In some example embodiments, the income is in the form of a standard in-game currency, a premium in-game currency, a real-world currency, or any suitable combination thereof. The trapped unit may be assigned to a mine belonging to the player, and generate income by working in the mine. The productivity of the trapped unit may be based on an attribute of the unit (e.g., an attack value of the unit, a defense value of the unit, a cost of the unit, a resistance value of the unit). A higher productivity may be reflected by producing a more-scarce resource (e.g., a premium currency instead of or in addition to a standard currency), by producing more of a resource each time resources are produced (e.g., producing 2 units of currency rather than 1), by producing currency more frequently (e.g., producing 1 unit of currency each hour rather than each 120 minutes), or any suitable combination thereof.

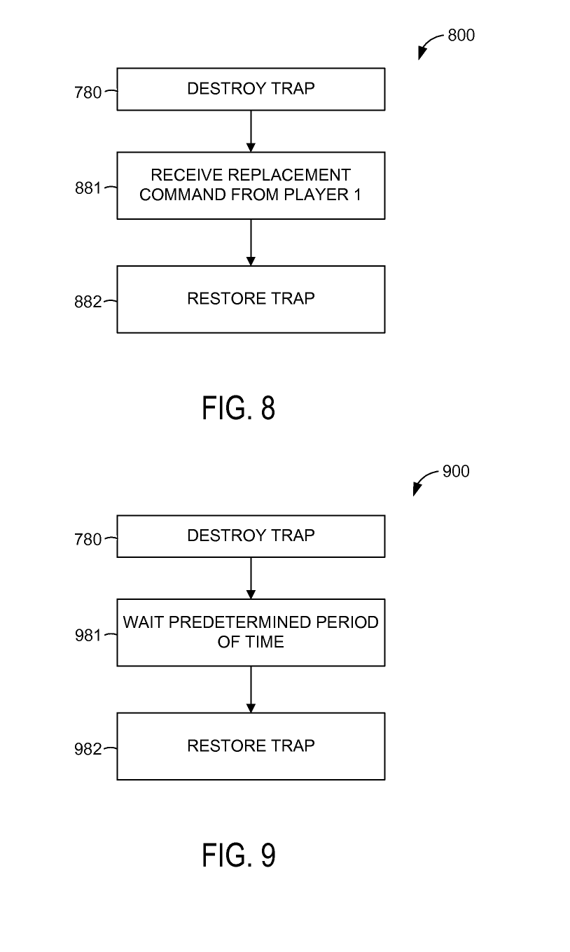

FIG. 8 is a flowchart illustrating operations of a method 800, according to some example embodiments, of handling traps in a game. The method 800 may be performed, for example, by the client system 130 or the game networking system 120b, using modules described above with respect to FIG. 3. By way of example and not limitation, this implementation is discussed below. As shown in FIG. 8, the method 800 includes operations 780, 881, and 882.

In operation 780, the trap module 360 removes or destroys a trap. Further details of operation 770 are described above with respect to FIG. 7.

In operation 881, the communications module 310 receives a command from the first player to replace the trap destroyed in operation 780. The command may be to replace a specific trap, to replace all destroyed traps, to recover from an attack, or any suitable combination thereof.

In operation 882, the trap module 360 replaces the destroyed trap. In some example embodiments, the trap module 360 deducts in-game resources from the first player's account to pay for the restoration of the trap. In some example embodiments, the game action itself is sufficient to restore the trap. In some example embodiments, the resource cost to replace the trap is less than the cost of initial placement. In some example embodiments, the resource cost to replace the trap is based on (e.g., a percentage of) the cost of the initial placement.

FIG. 9 is a flowchart illustrating operations of a method 900, according to some example embodiments, of handling traps in a game. The method 900 may be performed, for example, by the client system 130 or the game networking system 120b, using modules described above with respect to FIG. 3. By way of example and not limitation, this implementation is discussed below. As shown in FIG. 9, the method 900 includes operations 780, 981, and 982.

In operation 780, the trap module 360 removes or destroys the trap. Further details of operation 780 are described above with respect to FIG. 7.

In operation 981, the trap module 360 recognizes that a predetermined period of time has elapsed. After the predetermined period of time has elapsed, the trap is replaced in operation 982, which is the same as operation 882 as described above with respect to FIG. 8. In some example embodiments, the predetermined period of time may be short, allowing a single trap to capture multiple enemy units in the course of an attack. In some example embodiments, the period of time may be long (e.g., a day or more), allowing a player to be attacked multiple times between the destruction of the trap and its restoration. In other example embodiments, the trap may be restored as soon as the present attack is resolved.

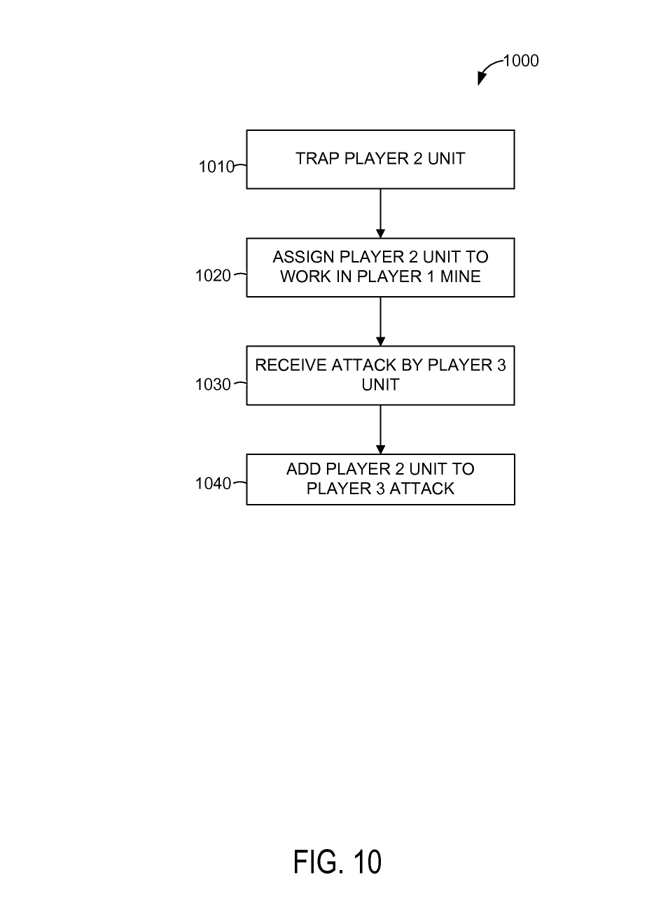

FIG. 10 is a flowchart illustrating operations of a method 1000, according to some example embodiments, of liberating trapped units in a game. The method 1000 may be performed, for example, by the client system 130 or the game networking system 120b, using modules described above with respect to FIG. 3. By way of example and not limitation, this implementation is discussed below. As shown in FIG. 10, the method 1000 includes operations 1010, 1020, 1030, and 1040.

In operation 1010, the trap module 360 may trap a unit belonging to player 2. For example, the method 700 may be used to trap the unit.

In operation 1020, the mine module 370 may assign the trapped unit to work in a mine belonging to the trapping player, player 1. In some example embodiments, this is part of operation 790, described above with respect to FIG. 7.

In operation 1030, the communications module 310 may receive an attack command from a third player. The attack command may indicate one or more units of the third player participating in the attack, one or more locations within the first player's territory to place the units, or both.

In operation 1040, the trap module 360 releases the trapped unit, and the trapped unit joins the attack by player 3 against player 1. The decision to release the trapped unit may be based on damage taken by the first player's mine, a guild affiliation between the second player and the third player, a guild relationship between the first player and the second player, a game attribute of the attacking unit, a game attribute of the trapped unit, or any suitable combination thereof. In some example embodiments, members of the same guild can see each other's traps. In other example embodiments, a player's traps are visible only to that player. In still other example embodiments, a player's traps are visible to all players.

According to various example embodiments, one or more of the methodologies described herein may facilitate trapping enemy units in a game. Moreover, one or more of the methodologies described herein may facilitate the production of in-game or real-world currency for a player.

When these effects are considered in aggregate, one or more of the methodologies described herein may obviate a need for certain efforts or resources that otherwise would be involved in trapping units. Efforts expended by a user in generating game resources may be reduced by one or more of the methodologies described herein. Computing resources used by one or more machines, databases, or devices (e.g., within the system 100) may similarly be reduced. Examples of such computing resources include processor cycles, network traffic, memory usage, data storage capacity, power consumption, and cooling capacity.

### Data Flow

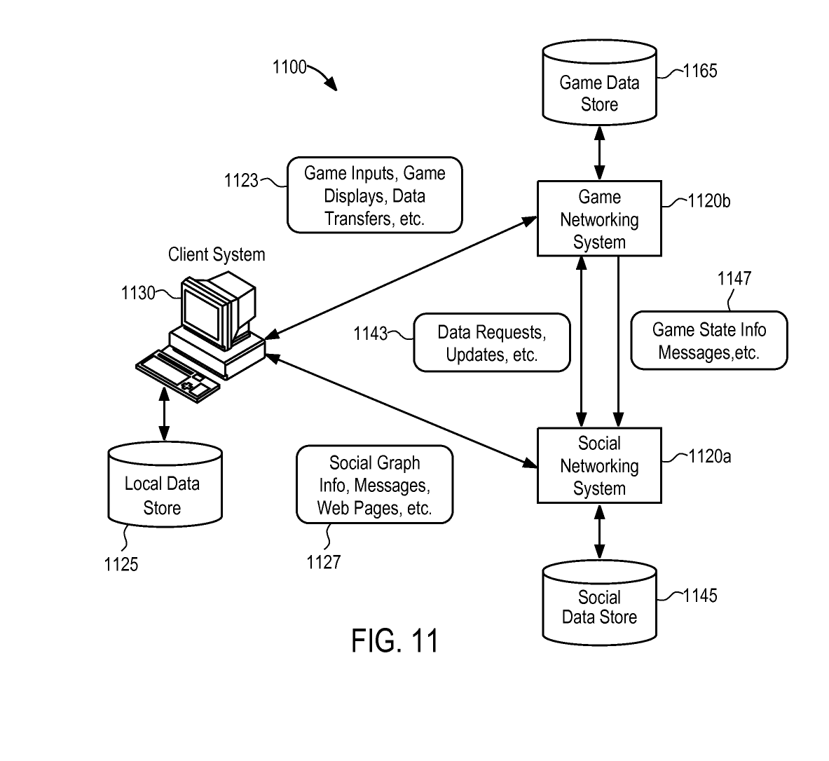

FIG. 11 is a flow chart illustrating an example data flow in a system 1100.

In particular embodiments, system 1100 can include client system 1130, social networking system 1120a, and game networking system 1120b. The components of system 1100 can be connected to each other in any suitable configuration, using any suitable type of connection. The components may be connected directly or over any suitable network. Client system 1130, social networking system 1120a, and game networking system 1120b can each have one or more corresponding data stores such as local data store 1125, social data store 1145, and game data store 1165, respectively. Social networking system 1120a and game networking system 1120b can also have one or more servers that can communicate with client system 1130 over an appropriate network. Social networking system 1120a and game networking system 1120b can have, for example, one or more internet servers for communicating with client system 1130 via the Internet. Similarly, social networking system 1120a and game networking system 1120b can have one or more mobile servers for communicating with client system 1130 via a mobile network (e.g., global system for mobile communications (GSM), partioning communication system (PCS), Wi-Fi, wireless personal area network (WPAN), etc.). In some embodiments, one server may be able to communicate with client system 1130 over both the Internet and a mobile network. In other embodiments, separate servers can be used.

Client system 1130 can receive and transmit data 1123 to and from game networking system 1120b. Data 1123 can include, for example, webpages, messages, game inputs, game displays, HTTP packets, data requests, transaction information, updates, and other suitable data. At some other time, or at the same time, game networking system 1120b can communicate data 1143, 1147 (e.g., game state information, game system account information, page info, messages, data requests, updates, etc.) with other networking systems, such as social networking system 1120a (e.g., Facebook, Myspace, etc.). Client system 1130 can also receive and transmit data 1127 to and from social networking system 1120a. This data 1127 can include, for example, webpages, messages, social graph information, social network displays, HTTP packets, data requests, transaction information, updates, and other suitable data.

Communication between client system 1130, social networking system 1120a, and game networking system 1120b can occur over any appropriate electronic communication medium or network using any suitable communications protocols. For example, client system 1130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as HTTP and other communications protocols, such as HTTP-S, FTP, SNMP, TELNET, and a number of other protocols, may be used. In addition, a server in one interaction context may be a client in another interaction context. In particular embodiments, the information transmitted between hosts may be formatted as HyperText Markup Language (HTML) documents. Other structured document languages or formats can be used, such as extended markup language (XML), and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1120b, the BLOB containing the game state for the instance corresponding to the player can be transmitted to client system 1130 for use by a client-side executed object to process. In particular embodiments, the client-side executable may be a FLASH-based game, which can de-serialize the game state data in the BLOB. As a player plays the game, the game logic implemented at client system 1130 maintains and modifies the various game state parameters locally. The client-side game logic may also batch game events, such as mouse clicks, and transmit these events to game networking system 1120b. Game networking system 1120b may itself operate by retrieving a copy of the BLOB from a database or an intermediate memory cache (memcache) layer. Game networking system 1120b can also de-serialize the BLOB to resolve the game state parameters and execute its own game logic based on the events in the batch file of events transmitted by the client to synchronize the game state on the server side. Game networking system 1120b may then re-serialize the game state, now modified, into a BLOB and pass this to a memory cache layer for lazy updates to a persistent database.

With a client-server environment in which the online games may run, one server system, such as game networking system 1120b, may support multiple client systems 1130. At any given time, there may be multiple players at multiple client systems 1130 all playing the same online game. In practice, the number of players playing the same game at the same time may be very large. As the game progresses with each player, multiple players may provide different inputs to the online game at their respective client systems 1130, and multiple client systems 1130 may transmit multiple player inputs and/or game events to game networking system 1120b for further processing. In addition, multiple client systems 1130 may transmit other types of application data to game networking system 1120b.

In particular embodiments, a computer-implemented game may be a text-based or turn-based game implemented as a series of web pages that are generated after a player selects one or more actions to perform. The web pages may be displayed in a browser client executed on client system 1130. As an example and not by way of limitation, a client application downloaded to client system 1130 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF object that is embedded in a web page and executable by a Flash media player plug-in. In particular embodiments, one or more described webpages may be associated with or accessed by social networking system 1120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1130, either caused by an action of a game player or by the game logic itself, client system 1130 may need to inform game networking system 1120b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1100 is discussed in reference to updating a multi-player online game hosted on a network-addressable system (such as, for example, social networking system 1120a or game networking system 1120b), where an instance of the online game is executed remotely on a client system 1130, which then transmits application event data to the hosting system such that the remote game server synchronizes game state associated with the instance executed by the client system 1130.

In a particular embodiment, one or more objects of a game may be represented as an Adobe Flash object. Flash may manipulate vector and raster graphics, and supports bidirectional streaming of audio and video. As used herein, “Flash” may mean the Flash authoring environment, the Flash player, or the Flash application files. In particular embodiments, client system 1130 may include a Flash client. The Flash client may be configured to receive and run Flash application or game object code from any suitable networking system (such as, for example, social networking system 1120a or game networking system 1120b). In particular embodiments, the Flash client may be run in a browser client executed on client system 1130. A player can interact with Flash objects using client system 1130 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1130, the Flash client may send the events that caused the game state changes to the in-game object to game networking system 1120b. However, to expedite the processing and hence the speed of the overall gaming experience, the Flash client may collect a batch of some number of events or updates into a batch file. The number of events or updates may be determined by the Flash client dynamically or determined by game networking system 1120b based on server loads or other factors. For example, client system 1130 may send a batch file to game networking system 1120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1130. In particular embodiments, the batch file may be a text file and the name-value pairs may be in string format.

In particular embodiments, when a player plays an online game on client system 1130, game networking system 1120b may serialize all the game-related data, including, for example and without limitation, game states, game events, user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1120b may retrieve the corresponding BLOB from the database to determine the most-recent values of the game-related data. In particular embodiments, while a player is playing the online game, game networking system 1120b may also load the corresponding BLOB into a memory cache so that the game system may have faster access to the BLOB and the game-related data contained therein.

### Systems and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

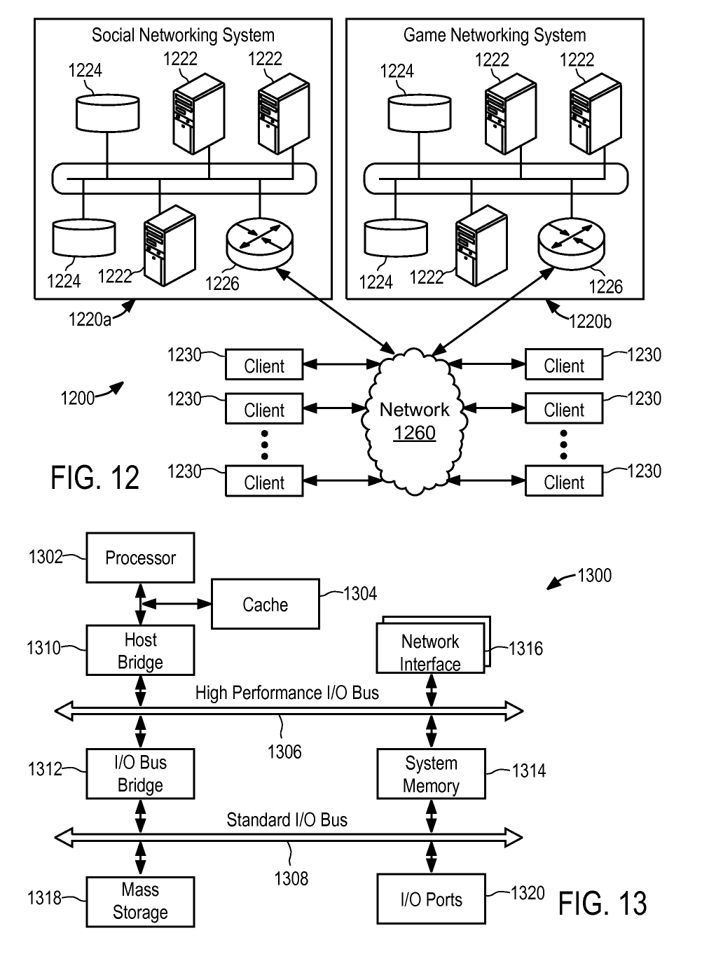

FIG. 12 is a network diagram illustrating an example network environment.

Particular embodiments may operate in a wide area network environment, such as the Internet, including multiple network-addressable systems.

FIG. 12 illustrates an example network environment 1200 in which various example embodiments may operate. Network cloud 1260 generally represents one or more interconnected networks, over which the systems and hosts described herein can communicate. Network cloud 1260 may include packet-based wide area networks (such as the Internet), private networks, wireless networks, satellite networks, cellular networks, paging networks, and the like. As FIG. 12 illustrates, particular embodiments may operate in a network environment 1200 comprising one or more networking systems, such as social networking system 1220a, game networking system 1220b, and one or more client systems 1230. The components of social networking system 1220a and game networking system 1220b operate analogously; as such, hereinafter they may be referred to simply at networking system 1220. Client systems 1230 are operably connected to the network environment 1200 via a network service provider, a wireless carrier, or any other suitable means.

Networking system 1220 is a network addressable system that, in various example embodiments, comprises one or more physical servers 1222 and data stores 1224. The one or more physical servers 1222 are operably connected to network cloud 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1222 may host functionality directed to the operations of networking system 1220. Hereinafter, servers 1222 may be referred to as server 1222, although server 1222 may include numerous servers hosting, for example, networking system 1220, as well as other content distribution servers, data stores, and databases. Data store 1224 may store content and data relating to, and enabling, operation of networking system 1220 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In particular embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

Client system 1230 is generally a computer or computing device including functionality for communicating (e.g., remotely) over a computer network. Client system 1230 may be a desktop computer, laptop computer, personal digital assistant (PDA), in- or out-of-car navigation system, smart phone or other cellular or mobile phone, or mobile gaming device, among other suitable computing devices. Client system 1230 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1230 to enter addresses of specific network resources to be retrieved, such as resources hosted by networking system 1220. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage, or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1230 desires to view a particular webpage (hereinafter also referred to as “target structured document”) hosted by networking system 1220, the user's web browser, or other document rendering engine or suitable client application, formulates and transmits a request to networking system 1220. The request generally includes a URL or other document identifier as well as metadata or other information. By way of example, the request may include information identifying the user, such as a user ID, as well as information identifying or characterizing the web browser or operating system running on the user's client system 1230. The request may also include location information identifying a geographic location of the user's client system 1230 or a logical network location of the user's client system 1230. The request may also include a timestamp identifying when the request was transmitted.

Although the example network environment 1200 described above and illustrated in FIG. 12 is described with respect to social networking system 1220a and game networking system 1220b, this disclosure encompasses any suitable network environment using any suitable systems. As an example and not by way of limitation, the network environment may include online media systems, online reviewing systems, online search engines, online advertising systems, or any combination of two or more such systems.

FIG. 13 is a block diagram illustrating an example computer system architecture, which may be used to implement a server 1222 or a client system 1230. In one embodiment, hardware system 1300 comprises a processor 1302, a cache memory 1304, and one or more executable modules and drivers, stored on a tangible computer readable medium, directed to the functions described herein. Additionally, hardware system 1300 may include a high performance input/output (I/O) bus 1306 and a standard I/O bus 1308. A host bridge 1310 may couple processor 1302 to high performance I/O bus 1306, whereas I/O bus bridge 1312 couples the two buses 1306 and 1308 to each other. A system memory 1314 and one or more network/communication interfaces 1316 may couple to bus 1306. Hardware system 1300 may further include video memory (not shown) and a display device coupled to the video memory. Mass storage 1318 and I/O ports 1320 may couple to bus 1308. Hardware system 1300 may optionally include a keyboard, a pointing device, and a display device (not shown) coupled to bus 1308. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1300 are described in greater detail below. In particular, network interface 1316 provides communication between hardware system 1300 and any of a wide range of networks, such as an Ethernet (e.g., IEEE 802.3) network, a backplane, etc. Mass storage 1318 provides permanent storage for the data and programming instructions to perform the above-described functions implemented in servers 1222, whereas system memory 1314 (e.g., DRAM) provides temporary storage for the data and programming instructions when executed by processor 1302. I/O ports 1320 are one or more serial and/or parallel communication ports that provide communication between additional peripheral devices, which may be coupled to hardware system 1300.

Hardware system 1300 may include a variety of system architectures and various components of hardware system 1300 may be rearranged. For example, cache memory 1304 may be on-chip with processor 1302. Alternatively, cache memory 1304 and processor 1302 may be packed together as a “processor module,” with processor 1302 being referred to as the “processor core.” Furthermore, certain embodiments of the present disclosure may neither require nor include all of the above components. For example, the peripheral devices shown coupled to standard I/O bus 1308 may couple to high performance I/O bus 1306. In addition, in some embodiments, only a single bus may exist, with the components of hardware system 1300 being coupled to the single bus. Furthermore, hardware system 1300 may include additional components, such as additional processors, storage devices, or memories.

An operating system manages and controls the operation of hardware system 1300, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (R) Windows (R) operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the data store 1224 is an example of a machine-readable medium and is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., hardware system 1300), such that the instructions, when executed by one or more processors of the machine (e.g., processor 1302), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, from a first client device of a first player of a computer-implemented game, a first move associated with the computer-implemented game, the first move comprising a placement of a trap at a trap location;
receiving, from a second client device of a second player of the computer-implemented game, a second move associated with the computer-implemented game, the second move comprising a first attack with a first unit, the first attack directed against the first player;
determining that a location of the first unit matches the trap location;
in an automated operation performed by one or more processors of a machine, trapping the first unit, the trapping including removing the first unit from the first attack; and
providing the first player with an amount of a game resource based on the trapping of the first unit and a time interval.

2. The method of claim 1, further comprising:
causing a representation of an area associated with the first player to be displayed on the second client device, the area including the trap location, the representation of the area excluding a representation of the trap.

3. The method of claim 1, wherein at least one of the amount and the time interval are based on an attribute of the first unit.

4. The method of claim 3, further comprising receiving, from the client device of the first player, a selection; and wherein at least one of the amount and the time interval is based on the selection.

5. The method of claim 1, further comprising:
receiving, after removing the first unit from the first attack, a third move associated with the computer-implemented game, the third move comprising a second attack with a second unit, the second attack directed against the first player; and
adding the first unit to the second attack.

6. The method of claim 1, further comprising removing the trap from the trap location based on the determining that the location of the first unit matches the trap location.

7. The method of claim 6 further comprising:
notifying the first player that the trap has been removed;
causing a user interface element to be presented to the first player, the user interface element operable to restore the trap; and
in response to operation of the user interface element, restoring the trap to the trap location.

8. The method of claim 6, further comprising restoring the trap to the trap location after a predetermined period of time has elapsed.

9. The method of claim 1, wherein removing the first unit from the first attack is based on a strength of the trap.

10. The method of claim 1, wherein removing the first unit from the first attack is based on a resistance of the first unit.

11. A system comprising:
a communications module configured to:
receive, from a first client device of a first player, a first move associated with a computer-implemented game, the first move comprising a placement of a trap at a trap location; and
receive, from a second client device of a second player, a second move associated with the computer-implemented game, the second move comprising a first attack with a first unit, the first attack directed against the first player;
a trap module configured to:
determine that a location of the first unit matches the trap location; and
trap the first unit by removing the first unit from the first attack; and
a mine module configured to provide the first player with an amount of a game resource based on the trapping of the first unit and a time interval.

12. The system of claim 11, wherein at least one of the amount and the time interval are based on an attribute of the first unit.

13. The system of claim 11, further comprising a display module configured to cause a representation of an area associated with the first player to be displayed on the second client device, the area including the trap location, the representation of the area excluding a representation of the trap.

14. The system of claim 11, wherein:
the communications module is further configured to receive, from the first client device of the first player, a selection; and
at least one of the amount and the time interval is based on the selection.

15. The system of claim 11, wherein
the communications module is further configured to receive, after the first unit is removed from the first attack, a third move associated with the computer-implemented game, the third move comprising a second attack with a second unit, the attack directed against the first player; and
the trap module is further configured to add the first unit to the second attack.

16. The system of claim 11, wherein the trap module is further configured to remove the trap from the trap location based on the determining that the location of the first unit matches the trap location.

17. The system of claim 14, wherein:
the communications module is further configured to notify the first player that the trap has been removed; and
the display module is further configured to:
cause a user interface element to be presented to the first player, the user interface element operable to restore the trap; and
in response to operation of the user interface element, restore the trap to the trap location.

18. The system of claim 16, wherein the trap module is further configured to restore the trap to the trap location after a predetermined period of time has elapsed.

19. A non-transitory machine-readable storage medium comprising instructions that, when executed by one or more processors of a machine, cause the machine to perform operations comprising:
receiving, from a first client device of a first player, a first move associated with a computer-implemented game, the first move comprising a placement of a trap at a trap location;
receiving, from a second client device of a second player, a second move associated with the computer-implemented game, the second move comprising a first attack with a first unit, the first attack directed against the first player;
determining that a location of the first unit matches the trap location;
removing the first unit from the first attack; and
providing the first player with an amount of a game resource based on the removing the first unit from the first attack and a time interval.

20. The non-transitory machine-readable storage medium of claim 19, wherein at least one of the amount and the time interval are based on an attribute of the first unit.
